(19) United States
(12) Patent Application Publication
(10) Pub. No.: US 2013/0318370 A1
(43) Pub. Date: Nov. 28, 2013

(54) MIDDLEWARE POWER MANAGEMENT

(71) Applicants: Eugene Gorbatov, Hillsboro, OR (US); Paul Diefenbaugh, Portland, OR (US)

(72) Inventors: Eugene Gorbatov, Hillsboro, OR (US); Paul Diefenbaugh, Portland, OR (US)

(73) Assignee: Intel Corporation, Santa Clara, CA (US)

(21) Appl. No.: 13/976,025

(22) PCT Filed: Dec. 30, 2011
(86) PCT No.: PCT/US2011/068236

§ 371 Date: Jun. 25, 2013

(51) Int. Cl. G06F 9/48

(52) U.S. Cl. CPC G06F 9/4893
USPC 713/300

(57) ABSTRACT

A system can include multiple devices each configured to run an application at an application level and each having varying performance, power, and other capabilities. A middleware power management facility spanning each of the devices can transfer applications from one device to another responsive to a determination based on capabilities of the devices, with the goal of optimizing the individual power consumption or collective energy efficiency of the devices, within application quality of service constraints.

### TECHNICAL FIELD

The disclosed technology relates generally to power management techniques for electronic devices and, more particularly, to power management techniques for systems composed of multiple devices.

### BACKGROUND

In current systems, power management policy and control typically resides in operating system software that supports lowest-common-denominator decisions for managing different hardware resources. Current operating system-driven power management (OSPM) infrastructures generally fail to comprehend, let alone adequately handle, specific application requirements and user context. Current OSPM infrastructure tends to control local resources only and has not been designed to support execution spanning multiple devices. In fact, given that different devices can run different operating systems, implementing power management within the operating system may not even be feasible in emerging systems.

Mobile systems and devices are increasingly running applications that are highly optimized for specific platforms and user experiences. As such, applications tend to have the most comprehensive view of performance and energy efficiency requirements, surrounding context, and ambient environment. At the same time, computing, memory, and storage resources comprising mobile devices are getting more diverse and heterogeneous. This heterogeneity comes from a greater usage of application-specific accelerators, evolving memory, and storage hierarchy enabled by new memory technologies and a variety of wireless communication options that are widely available in today's systems. In addition, application execution can span multiple devices. Applications migrate between devices or execute across multiple devices to provide the best user experience in what is known as compute continuum. This migration is driven by energy efficiency, performance, and functionality considerations. Applications often utilize resources across different devices in an attempt to offer the best user experience.

Power management in current devices is a shared responsibility between hardware and operating systems. The OS typically controls power and performance states (e.g., P-states and C-states) and hardware generally applies its own control mechanisms to meet physical specifications, e.g., thermal and power requirements, of its circuits and logic. As devices get more heterogeneous, execution begins to span multiple devices that potentially run different operating systems or multiple independent copies of the same operating system. Given this, and because applications are optimized for specific hardware capabilities and user context, the task of power managing a system needs to be moved closer to applications and be able to span multiple devices. Applications having their own power management would be the next logical alternative, but such arrangements are generally not feasible.

Thus, there remains a need for improved power management techniques for systems configured for multiple devices and also for application-centered computing systems that are built upon middleware, where the confluence leads to placing power management ownership in the middleware.

### BRIEF DESCRIPTION OF THE DRAWINGS

Embodiments of the disclosed technology are illustrated by way of example, and not by way of limitation, in the drawings and in which like reference numerals refer to similar elements.

FIG. 1 is a block diagram illustrating an example of a current power management architecture for use in systems configured to handle multiple devices.

FIG. 2 illustrates a first example of a middleware power management architecture for use in systems configured to handle multiple devices in accordance with embodiments of the disclosed technology.

FIG. 3 illustrates a second example of a middleware power management architecture for use in systems configured to handle multiple devices in accordance with embodiments of the disclosed technology.

FIG. 4 illustrates an example of a first method of power management as pertaining to systems configured to handle multiple devices in accordance with embodiments of the disclosed technology.

FIG. 5 illustrates an example of a second method of power management as pertaining to systems configured to handle multiple devices in accordance with embodiments of the disclosed technology.

### DETAILED DESCRIPTION

Certain embodiments of the disclosed technology include new techniques and architecture for power management as pertaining to mobile devices where the power management functionality and control resides in application middleware. These implementations may enable various types of applications to discover energy efficiency characteristics of hardware resources that span one or more devices while managing power and thermal considerations across a physical device boundary based on specific application requirements as well as ambient and execution contexts. For example, certain embodiments include mechanisms for discovering and controlling power and thermal characteristic of various hardware resources that may be located in different physical devices, e.g., desktop or laptop computers, handheld computing devices such as tablet devices, or mobile devices such as smartphones. Embodiments may include extracting user context and application requirements in middleware and implementing power management policies that use native interfaces defined in hardware.

Certain implementations include a new facility that will be referred to herein as middleware power management (MWPM), which implements power management policy and control in application middleware. MWMP can span multiple physical devices, can be operating system (OS) independent, and may access the underlying hardware-controlled power management (HWPM) infrastructure through the OS-driven power management (OSPM) infrastructure or directly through hardware interfaces. In certain embodiments, the MWPM may be tightly coupled with applications and end-user contextual environment, thus enabling the design of power management policies that are application specific and fine-tuned for optimal individual user experiences.

In certain embodiments, hardware may be used to control power management tasks at the physical level to ensure that energy-efficient operation is achieved and that pertinent physical power and thermal constraints are met. A hardware-controlled power management (HWPM) facility may be implemented to expose a set of interfaces for providing performance and energy efficiency guidance for different resources in the system, e.g., system-on-a-chip (SoC). For example, hardware may expose performance levels that are available for different heterogeneous cores and accelerators in the system and allow higher-level software, such as MWPM, to specify the desired performance for a particular core or accelerator.

In certain embodiments, an operating system power management (OSPM) facility may be implemented to provide power management facilities for system, e.g., SoC, and input/output (I/O) resources in the system. The OSPM facility may expose hardware capabilities and supported interfaces for different I/O devices and system components. Unlike current systems, an OSPM facility in accordance with the disclosed technology does not need to implement power management policies and control; rather, the OSPM facility may expose hardware capabilities and power management interfaces on a local device to user applications. In certain implementations, the OSPM facility can be bypassed such that HWPM facility interfaces may be used directly by higher-level software.

In certain embodiments, a middleware power management (MWPM) facility may be implemented to host a power management policy and control infrastructure that can span multiple physical devices as well as multiple operating systems. The MWPM facility may be used. to expose interfaces to applications in order to specify quality of service requirements, execution and functionality requirements, and power/energy preferences. The MWPM facility may be used to implement power management policies and control mechanisms that can comprehend execution resources that may be scattered among different devices, account for different trade-offs regarding the use of computational, memory, and network resources that are located both locally and remotely, and also take into account user context and ambient environment considerations.

Power management policies implemented in connection with certain embodiments of a MWPM facility can be application-specific and also tuned/optimized for a particular user experience. In addition to managing power, the MWPM facility may implement multiple facilities for discovering energy efficiency characteristics of local and remote hardware resources and also support applications and other middleware components in making migration and resource configuration decisions, for example.

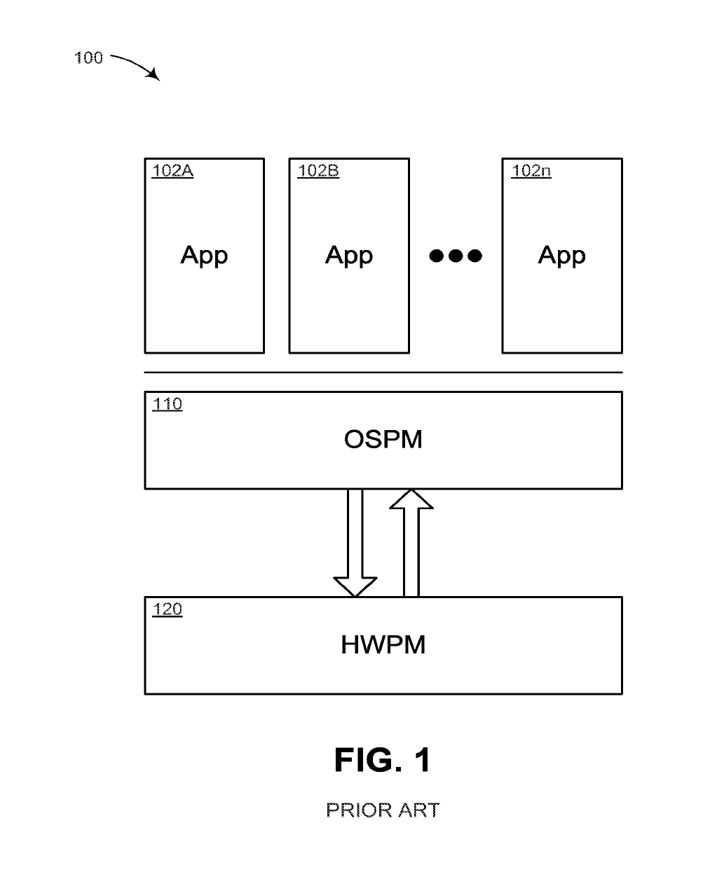

FIG. 1 is a block diagram illustrating an example of a current power management architecture 100 for use in systems configured to handle a single device, e.g., a mobile device such as a laptop computer, handheld computing device such as a tablet device, smartphone, etc. An operating system-driven power management (OSPM) infrastructure 110 and a hardware-controlled power management (HWPM) infrastructure 120 work together to provide power management capabilities with regard to each of a number of applications 102A-102n. This stack (e.g., 102A-102n, 110, and 120) is replicated on each device.

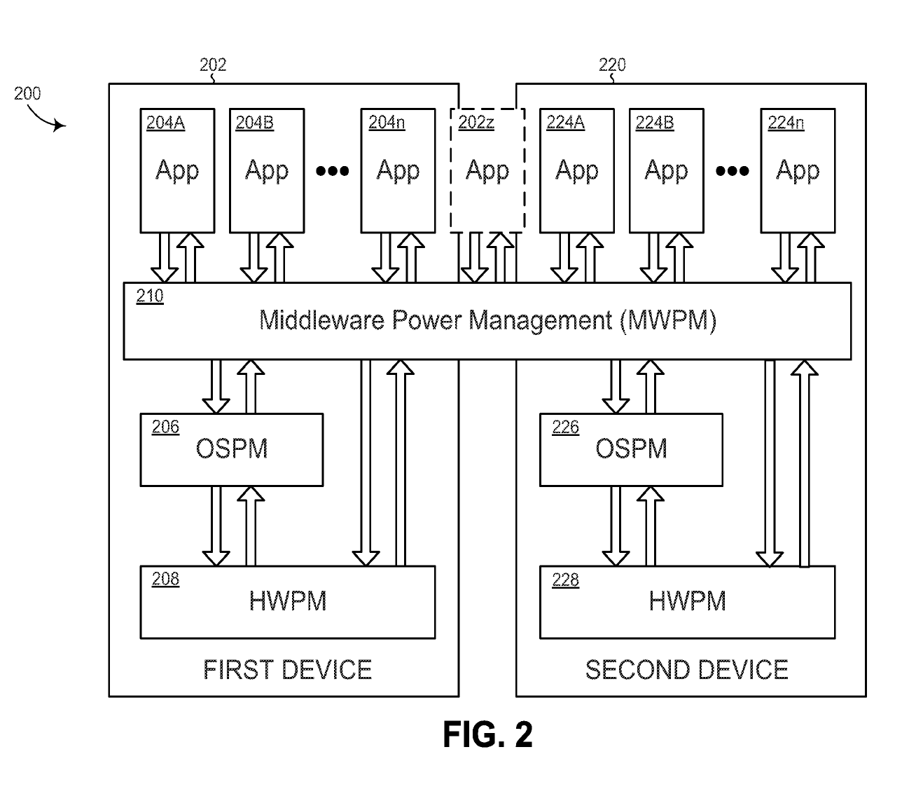

FIG. 2 illustrates a first example of a middleware power management architecture 200 for use in systems configured to handle one or more devices in accordance with embodiments of the disclosed technology. The example includes two devices 202 and 220. The first device 202 is running a number of applications 204A-204n and the second device 220 is also running a number of applications 224A-224n. In certain embodiments, an application 202z spans both of the devices 202 and 220. The first and second devices 202 and 220 can each be any of a number of electronic devices such as desktop or laptop computers, handheld computing devices such as tablet devices, smartphones, etc.

The first device has an OSPM facility 206 and a HWPM facility 208 that may interact with each other concerning certain aspects of power management as it pertains to any or all of the applications 204A-204n that are running on the first device 202. Similarly, the second device has an OSPM facility 226 and a HWPM facility 228 that may interact with each other concerning certain aspects of power management as it pertains to any or all of the applications 224A-224n that are running on the second device 220.

In the example, the power management architecture 200 further includes a middleware power management (MWPM) facility 210 that is implemented in middleware and controls platform power, e.g., power management preferences, quality-of-service (QoS) constraints, etc., with regard to any or all of the applications 204A-204n running on the first device 202 as well as any or all of the applications 224A-224n running on the second device 220. The MWPM facility 210 is able to span multiple physical devices, e.g., the first device 202 and the second device 220. As used herein, ‘spanning’ may include two instances of middleware that collaborate to achieve MWPM or a single instance, executable, spanning multiple devices, or any of a number of variations.

Any of all of the applications 204A-204n and 224A-224n may provide the MWPM facility 210 with QoS and related information, The MWPM facility 210 may characterize and tune any or all of the applications 204A-204n and 224A-224n in accordance with the pertinent hardware platform, thus determining QoS requirements that may be conveyed to either or both of the HWPM facilities 208 and 228. Such requirements may be used for migration, power management, and other policy optimizations performed by the MWPM facility 210.

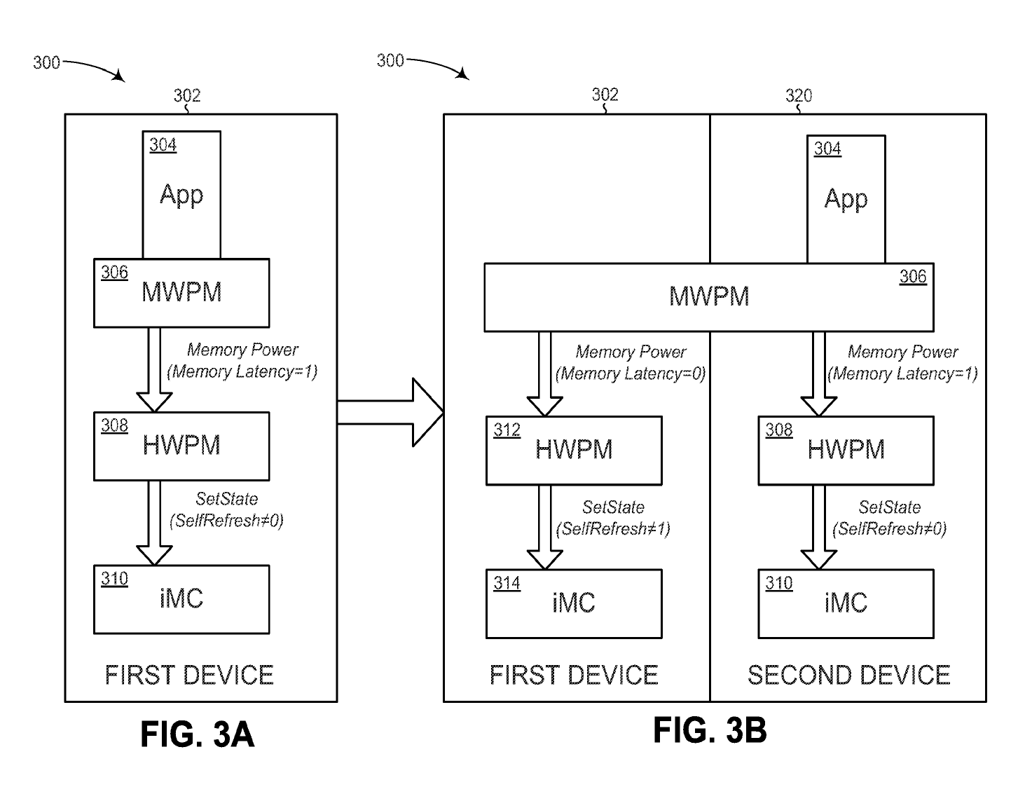

FIGS. 3A-3B illustrates a second example of a middleware power management architecture 300 for use in systems configured to handle multiple devices in accordance with embodiments of the disclosed technology. In the example illustrated by FIG. 3A, an application 304 is running on a first device 302 and uses a local memory of the device 302 as a resource. A MWPM facility 306 is able to detect that the application 304 is latency-sensitive and may communicate this information to a HWPM facility 308. Subsequently, the HWPM facility may disable a self-refresh state in an integrated memory controller (iMC) 310 of the first device 302 when the application processor is active, e.g., in a C₀ state.

At some point in time, the first device 302 comes into the proximity of a more capable system, e.g., having a larger display, additional computational resources, and/or greater battery power. For example, a user using a smartphone may enter his or home from the outside and, consequently, bring the smartphone into the proximity of his or her home network, which includes a premium desktop computer. Upon determining that the first device 302 has entered the proximity, the MWPM facility 306 may seek confirmation of such. For example, the MWPM facility 306 may not take any action unless the first device 302 has remained within the proximity for a certain amount of time.

Responsive to a determination/confirmation that the first device 302 is indeed within the proximity of the other system, the MWPM facility 306 on the first device 302 may decide to migrate, e.g., shift or transfer, the application 304 on the first device to another device, e.g., the second device 320 of FIG. 3B. In the example illustrated by FIG. 3B, the application 304 is now executing on the second device 320.

As a result of the hardware configuration of FIG. 3B, the MWPM facility 306 may reset its memory latency requirements on the first device 302, from 0 to 1, thus allowing the iMC 310 on the first device 302 to enter a power-efficient memory self-refresh state. The MWPM facility 306 may also set a new memory latency constraint on the second device 320, e.g., from 1 to 0, due to the application 304 now executing on the second device 320. Alternatively or in addition to memory latency requirements, other power management parameters such as processor C-states and P-states, uncore states, interconnect states, etc. may be tuned.

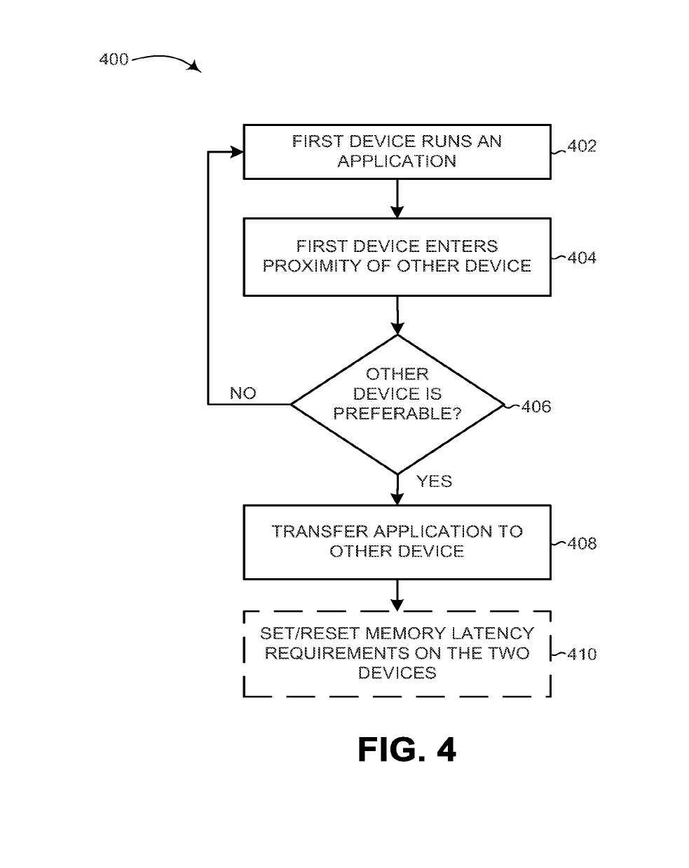

FIG. 4 illustrates an example of a first method 400 of power management as pertaining to systems configured to handle multiple devices in accordance with embodiments of the disclosed technology. At 402, a first device, such as the first device 302 of FIG. 3A, is running an application, such as the application 304 of FIG. 3A. The first device may be any of a number of different electronic devices such as a laptop computer, handheld computing device, table device, smartphone, etc.

At 404, the first device enters the proximity of a system or another device, such as the second device 320 of FIG. 3B. For example, a user may be carrying the first device as he or she enters a building, which has a wireless network that is accessible to the user, from the outside, where there is no access or limited access to the network inside the building. The wireless network may allow for connections between any of a number of devices such as desktop computers, servers, or portable devices such as tablet devices and smartphones.

At 406, a determination is made as to whether the other device has performance, power, human input/output, or other capabilities that are preferable over those of the first device. For example, a MWPM facility on the first device may identify a second device, such as the second device 320 of FIG. 3B, that is presently connected to the network. In certain embodiments, such determination may also depend on a confirmation by ensuring that the connection lasts for a certain amount of time or has a certain signal strength before taking further action. For example, the first device may determine that the system has greater power capabilities but, due to identified concerns such as connectivity issues, the MWPM facility on the first device may deem the power capabilities of the other device not preferable over those of the first device, at least not at the current time.

Responsive to a determination that the power capabilities of the other device are preferable to those of the first device, the MWPM facility on the first device may interact with the MWPM facility on the second device to transfer execution of the application to the other device, as indicated at 408; otherwise, the method 400 generally returns to 402, e.g., the application continues to run on the first device. If the application is transferred to the second device, the memory latency requirement on the first device may optionally be reset and a new memory latency constraint may optionally be set on the second device, as indicated at 410.

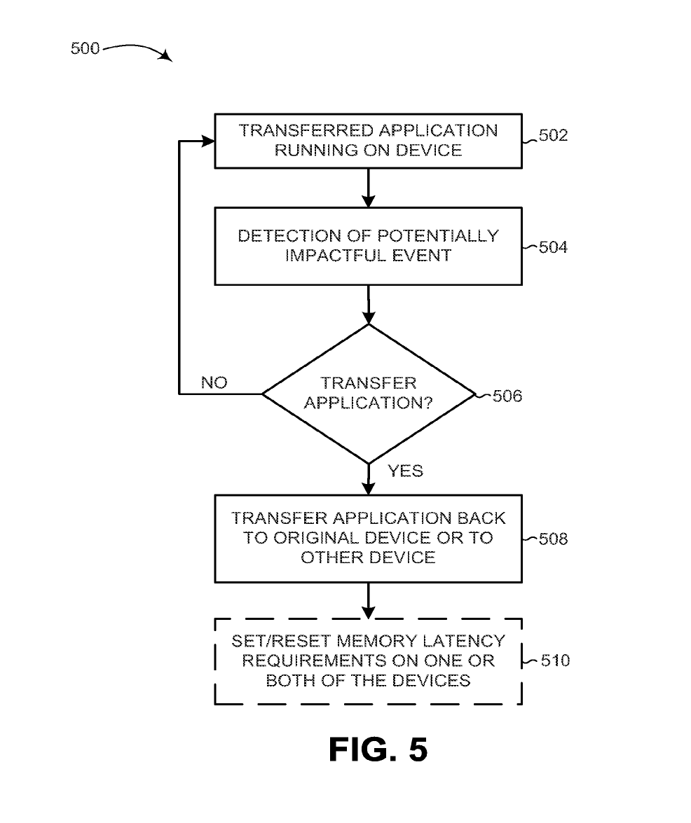

FIG. 5 illustrates an example of a second method 500 of power management as pertaining to systems configured to handle multiple devices in accordance with embodiments of the disclosed technology. At 502, a transferred application is running on a second device, e.g., the application 304 that was originally running on the first device 302 of FIG, 3A but is now running on the second device 320 of FIG. 3B.

At 504, an event that may affect the running of the transferred application on the current device is detected. In one example, the original device on which the application was running may leave the proximity of the other device on which the application is currently running, e.g., a user may physically leave the vicinity of the network over which the two devices are connected. In an alternate example, the MWPM facility that spans the two devices may determine that the second device is running low on power and, therefore, the application may cease running on the second device.

At 506, a determination is made as to whether the application should be transferred. away from the device, e.g., back to the original device or to another device. For example, the MWPM facility may wish to confirm that the performance requirements of the application would be met on the original device and, if not, whether there is another available device on which the performance requirements would be met. The MWPM facility may also take into account whether a user is currently interacting with the application or if the application is running partially or completely in the background, e.g., independent of user interaction.

Certain implementations of the disclosed technology include MWPM architectures that may achieve energy efficiency optimizations. Such embodiments may include the ability to characterize both applications and devices and shift applications for execution on the device(s) that would provide the best system-wide, e.g., collective, energy efficiency while meeting application QoS constraints.

In certain embodiments, a MWPM architecture may make one or more policy decisions, e.g., transferring or spanning execution of an application, to improve the user-perceived responsiveness, quality, and other aspects of the application as experienced by the end-user. Knowing/determining multiple application QoS levels, e.g., minimum, good, and great, enables the MWPM architecture to effectively and efficiently map the application requirements to the optimal set of hardware on one or potentially multiple devices.

In the example, responsive to a determination that the application should be transferred to another device, e.g., the first device or another presently available device, the MWPM facility on the device may interact with the MWPM facility on the other device to transfer execution of the application to the other device, as indicated at 508; otherwise, the method 500 generally returns to 502, e.g., the application continues to run on the same device. If the application is transferred to the other device, the memory latency requirements on either or both of the devices may be adjusted accordingly, as indicated at 510.

Embodiments of the disclosed technology may be incorporated in various types of architectures. For example, certain embodiments may be implemented as any of or a combination of the following: one or more microchips or integrated circuits interconnected using a motherboard, a graphics and/or, video processor, a multicore processor, hardwired logic, software stored by a memory device and executed by a microprocessor, firmware, an application specific integrated circuit (ASIC), and/or a field programmable gate array (FPGA). The term “logic” as used herein may include, by way of example, software, hardware, or any combination thereof.

Although specific embodiments have been illustrated and described herein, it will be appreciated by those of ordinary skill in the art that a wide variety of alternate and/or equivalent implementations may be substituted for the specific embodiments shown and. described without departing from the scope of the embodiments of the disclosed technology. This application is intended to cover any adaptations or variations of the embodiments illustrated and described herein. Therefore, it is manifestly intended that embodiments of the disclosed technology he limited only by the following claims and equivalents thereof.

What is claimed is:

1. A system, comprising:
a first device configured to run an application at a first application level, the first device having a first power capability;
a second device configured to run the application at a second application level, the second device having a second power capability; and
middleware power management (MWPM) facility spanning each of the first and second devices and configured to transfer the application from the first device to the second device responsive to a determination based at least in part on the first and second power capabilities.

2. The system of claim 1, wherein the first device comprises a first operating system-driven power management (OSPM) facility, and wherein the MWPM facility resides between the first OSPM facility and the first application level on the first device.

3. The system of claim 2, wherein the second device comprises a second OSPM and wherein the MWPM facility resides between the first OSPM facility and the second application level on the second device.

4. The system of claim 1, wherein the first device comprises a first hardware-controlled power management (HWPM) facility, and wherein the MWPM facility resides between the first HWPM facility and the first application level on the first device.

5. The system of claim 2, wherein the second device comprises a second hardware-controlled power management (HWPM) facility, and wherein the MWPM facility resides between the second HWPM facility and the second application level on the second device.

6. The system of claim 1, wherein each of the first and second devices comprises one of a group consisting of: a laptop computer, a handheld computing device, a tablet computing device, and a smartphone.

7. A method, comprising:
a first device running an application;
a second device configured to run the application;
the first device entering a proximity of a second device;
a middleware power management (MWPM) facility that spans the first and second devices determining whether the application is to be transferred from the first device to the second device, wherein the determining is based at least in part on a power capability of the second device; and
responsive to the determining, the MWPM facility transferring the application to the second device.

8. The method of claim 7, wherein the determining is further based on a power capability of the first device.

9. The method of claim 8, wherein the power capability of the second device is determined to have a quality that exceeds that of the power capability of the first device, the quality comprising at least one of a group consisting of: amount, quality, efficiency, and reliability.

10. The method of claim 7, further comprising resetting a memory latency requirement on the first device responsive to the transferring.

11. The method of claim 7, further comprising setting a memory latency requirement on the second device responsive to the transferring.

12. The method of claim 7, further comprising the MWPM facility detecting an event that may impact the application running on the second device.

13. The method of claim 12, wherein the event comprises one of a group consisting of: the first device leaving the proximity of the second device, an actual impairment of the power capability of the second device, and a potential impairment of the power capability of the second device.

14. The method of claim 12, further comprising the MW PM facility determining whether the application is to be transferred from the second device back to the first device responsive to the detecting.

15. The method of claim 12, further comprising the MWPM facility determining whether the application is to be transferred from the second device to a third device responsive to the detecting.

16. The method of claim 7, wherein the first device entering the proximity of the second device comprises the first device detecting a network to which the second device is connected.

17. A mobile device, comprising:
a processor for executing an application at an application level;
a memory for storing information pertaining to the application;
a power supply for providing power for the processor, the power supply having a power capability;
an operating system-driven power management (OSPM) facility for at least partially managing power for the application; and
a middleware power management (MWPM) facility between the OSPM facility and the application level and configured to transfer the application to another device.

18. The mobile device of claim 18, wherein the MWPM facility is configured to transfer the application to the other device responsive to a determination that a power capability of the other device is greater than the power capability of the power supply.

19. The mobile device of claim 18, further comprising a hardware-controlled power management (HWPM) facility for at least partially managing the power for the application.

20. The mobile device of claim 19, wherein the MWPM is further between the HWPM and the application level.
